(19) United States
(12) Patent Application Publication
(10) Pub. No.: US 2017/0255541 A1
(43) Pub. Date: Sep. 7, 2017

(54) DEVICE AND METHOD FOR CONFIGURING MONITORING ENVIRONMENT OF APPLICATION

(71) Applicant: ELECTRONICS AND TELECOMMUNICATIONS RESEARCH INSTITUTE, Daejeon (KR)

(72) Inventor: Jeong-Si KIM, Daejeon (KR)

(21) Appl. No.: 15/206,796

(22) Filed: Jul. 11, 2016

(30) Foreign Application Priority Data
Mar. 3, 2016 (KR) 10-2016-0025848

(51) Int. Cl. G06F 11/34; G06F 11/30; G06F 11/36

(52) U.S. Cl. CPC G06F 11/3495; G06F 11/3668; G06F 11/302

(57) ABSTRACT

A method for configuring a monitoring environment of an application includes a monitoring location analysis step for detecting a monitoring location candidate, and a monitoring range analysis step for detecting a monitoring range, wherein the monitoring location analysis step includes receiving a source file of a general application, input m units of source lines, when an input source line is an execution line, calculating an execution load of the input source line, and determining a source line having the greatest execution load as a monitoring location candidate. Accordingly, it is possible to provide a method for determining an optimal performance monitoring location and an optimal performance monitoring range, which are required to configure an execution environment of a self-adaptive application, so as to perform efficient performance monitoring of the self-adaptive application.

### CROSS-REFERENCE TO RELATED APPLICATION

This application claims priority to and the benefit of Korean Patent Application No. 10-2016-0025848, filed on Mar. 3, 2016, in the Korean Intellectual Property Office, the entire contents of which are incorporated herein by reference in their entirety.

### BACKGROUND

1. Field

An aspect of the present disclosure relates to a technique for supporting effective execution of a self-adaptive application for self-adaptive computing, and more particularly, to a method for determining an optimal performance monitoring location and an optimal performance monitoring range, which are required to configure an execution environment of a self-adaptive application, so as to perform efficient performance monitoring of the self-adaptive application.

2. Description of the Related Art

The creation of a self-adaptive application executable in a self-adaptive system is required to use a self-adaptive computing technique. In the self-adaptive system, performance monitoring of the self-adaptive application is essential so as to achieve performance optimization of the self-adaptive application. The performance monitoring is generally performed using self-adaptive application development application program interface (API) that provides an interface through which the self-adaptive system receives performance targets and performance data, transmitted from the self-adaptive application.

However, it is not easy to create an optimal self-adaptive application using the self-adaptive application development API. This is because a developer should have knowledge and understanding of self-adaptive systems and runtimes of self-adaptive applications so as to configure a monitoring environment for determining the accuracy of monitoring results such as a monitoring location and a monitoring range when an application created using a related API is monitored.

Additional efforts and responsibilities, required to developers, make it difficult to develop self-adaptive applications, which imposes limitations on the use of self-adaptive computing.

### SUMMARY

Embodiments provide a device and a method for configuring an optimal monitoring environment of a self-adaptive application so as to maximize effects of the self-adaptive application, which can support a developer to easily develop a highly effective self-adaptive application even though the developer lacks knowledge and understanding of self-adaptive systems and runtimes of self-adaptive applications.

According to an aspect of the present disclosure, there is provided a method for configuring a monitoring environment of an application, the method including: a monitoring location analysis step for detecting a monitoring location candidate; and a monitoring range analysis step for detecting a monitoring range, wherein the monitoring location analysis step includes: receiving a source file of a general application, input in units of source lines, when an input source line is an execution line, calculating an execution load of the input source line; and determining a source line having the greatest execration load as a monitoring location candidate.

The monitoring range analysis step may include: generating a monitoring code; receiving the source file of the general application, input in units of source lines; and when an input source line is a monitoring location candidate, installing the monitoring code in the input source line.

The monitoring range analysis step may further include installing a control code capable of controlling whether the monitoring code is to be activated in the source line in which the monitoring code is installed.

The monitoring range analysis step may further include: executing an application for monitoring range analysis, in which the monitoring code is installed; and detecting a monitoring range of the source line in which the monitoring code is installed, using performance data generated in the executing of the application for monitoring range analysis.

The method may further include a monitoring environment configuration step for configuring a monitoring environment.

The monitoring environment configuration step may include: receiving the source file of the general application in units of source lines; and when an input source line is a monitoring location candidate, installing an application monitoring application program interface (API) in the input source line.

The application monitoring API may have a monitoring range detected through the monitoring range analysis step.

The execution load may be determined by reflecting at least one of a number of execution times of a source line and a central processing unit (CPU) utilization of the source line.

According to an aspect of the present disclosure, there is provided a device for configuring a monitoring environment of an application, the device including: a monitoring location analyzer configured to receive a general application input, to detect a monitoring location candidate; a monitoring range analysis code configurator configured to receive the general application input, to generate an application for monitoring range analysis; and a monitoring range analyzer configured to receive the application for monitoring range analysis, input, to detect, a monitoring range.

The monitoring location analyzer may include: an execution line identifier configured to identify an execution line included in the source file of the general application; an execution load calculator configured to calculate an execution load of the identified execution line; and a monitoring location candidate generator configured to determine a source line having the greatest execution load as a monitoring location candidate.

The monitoring range analysis code configurator may include: a monitoring code generator configured to generate a monitoring code; and a monitoring code installer configured to install the monitoring code in the source line determined as the monitoring location candidate.

The monitoring range analyzer may include: a monitoring code line identifier configured to identify a source line in which the monitoring code is installed from the application for monitoring range analysis; a monitoring range analysis application executer configured to execute the application for monitoring range analysis; and a monitoring range candidate generator configured to detect a monitoring range of the source line in which the monitoring code is installed.

The device may further include a monitoring environment configurator configured to receive the general application input, to generate a self-adaptive application.

The monitoring environment configurator may include: a monitoring location configurator configured to install an application monitoring API in the source line of the general application, corresponding to the monitoring location candidate; and a monitoring range configurator configured to provide the application monitoring API with the monitoring range detected by the monitoring range analyzer.

The execution load may be determined by reflecting at least one of a number of execution times of the input source line and a CPU utilization of the input source line.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a device for configuring a monitoring environment of an application according to an embodiment of the present disclosure.

FIG. 2 is a flowchart illustrating a method for configuring a monitoring environment of an application according to an embodiment of the present disclosure.

FIG. 3 is a flowchart illustrating a monitoring location analysis step of FIG. 2.

FIG. 4 is a flowchart illustrating a monitoring range analysis step of FIG. 2.

FIG. 5 is a flowchart illustrating a monitoring environment configuration step of FIG. 2.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Throughout the drawings, like elements are designated by like reference numerals.

Hereinafter, a device and a method for configuring a monitoring environment of an application according to embodiments of the present disclosure will be described with reference to the accompanying drawings.

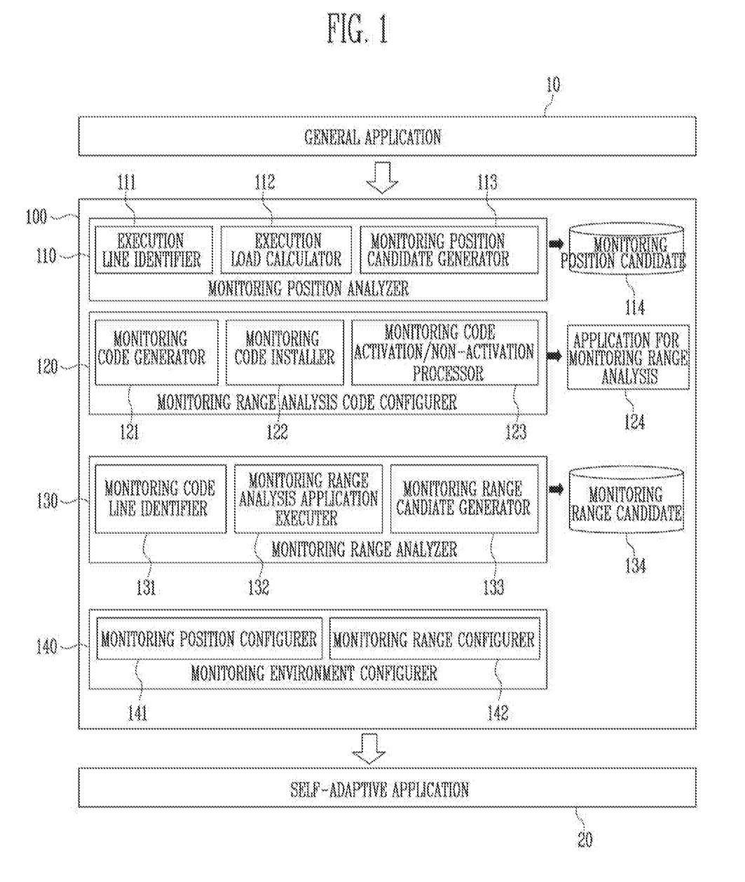

FIG. 1 is a diagram illustrating a device for configuring a monitoring environment of an application according to an embodiment of the present disclosure.

The device 100 according to the embodiment of the present disclosure is a device that supports the configuration of an optimal monitoring environment of a self-adaptive application in development of the application. Referring to FIG. 1, the device 100 may include a monitoring location analyzer 110, a monitoring range code configurator 120, a monitoring range analyzer 130, and a monitoring environment configurator 140.

The monitoring location analyzer 110 may receive a general application 10 input, to detect a monitoring location candidate from the general application 10.

To this end, the monitoring location analyzer 110 may include an execution line identifier 111, an execution load calculator 112, and a monitoring location candidate generator 113.

The execution line identifier 111 may identify an execution line included in the source file of the general application 10.

For example, the general application 10 may include a plurality of source lines, and the execution line identifier 111 may identify, as the execution line, a source line in which a number of execution times exists among the plurality of source lines.

The execution load calculator 112 may calculate as execution load of the execution line identified by the execution line identifier 111.

For example, the execution load calculator 112 may calculate an execution load of a source line identified as the execution line by the execution line identifier 111. When a plurality of execution lines exist, the execution load calculator 112 may calculate an execution load of each of the plurality of execution lines.

The execution load may be determined by reflecting at least one of a number of execution times of a corresponding source line and a central processing unit (CPU) utilization of the corresponding source line. At this time, the execution load can be calculated by arbitrarily executing the general application 10 and counting the number of the execution times of each of the execution lines while the general application 10 is executing.

The monitoring, location candidate generator 113 may determine a source line having the greatest execution load as the monitoring location candidate.

For example, the monitoring location candidate generator 113 may determine, as the monitoring location candidate, a source line having the greatest execution load among at least one source line identified as the execution line.

The monitoring location candidate may include a source line haying an execution load within a certain ranking, in addition to the source line having the greatest execution load.

That is, the monitoring location candidate may include a plurality of source lines according to a configuration of a developer, a user, or the like. For example, the monitoring location candidate may include n (n is a natural number of 2 or more) source lines from the highest rank, based on the execution load.

Information on the monitoring location candidate may be stored in a storage unit 114.

The monitoring range analysis code configurator (the monitoring range configurator) 120 may receive the general application 10 input, to generate an analytical application 124 for monitoring range analysis, which can perform monitoring range analysis.

To this end, the monitoring range analysis code configurator 120 may include a monitoring code generator 121, a monitoring code installer 122, and a monitoring code activation/non-activation processor 123.

The monitoring code generator 121 may generate a monitoring code to be used as a code for monitoring range analysis.

Here, the monitoring code may monitor the performance of a specific source line, and measured performance data may be used to detect a monitoring range (range of performance values of interest) which will be described later.

The monitoring code installer 122 may install the monitoring code generated by the monitoring code generator 121 in a source line determined as a monitoring location candidate.

For example, the monitoring code installer 122 may insert the monitoring code into the corresponding monitoring location candidate with reference to the information on the monitoring location candidate, stored in the first storage unit 114. The monitoring code inserted into the monitoring location candidate may monitor the performance of the monitoring location candidate.

The monitoring code activation/non-activation processor 123 may control whether the monitoring code installed by the monitoring code installer 122 is to be activated.

For example, when a plurality of monitoring codes are installed because a plurality monitoring location candidates exist, the monitoring code activation/non-activation processor 123 may activate only a portion of the monitoring codes.

For example, the monitoring code activation/non-activation processor 123 may control monitoring codes such that only one monitoring code is activated when the analytical application 124 is executed once.

In order to control whether the monitoring code is to be activated, the monitoring code activation/non-activation process 123 may install a separate control code capable of activation/non-activation monitoring code.

Through the above-described procedure, the monitoring range analysis code configurator 120 can generate the analytical application 124 in which the monitoring code of the monitoring code/control code is installed.

The monitoring range analyzer 130 receive the analytical application 124 input, to detect a monitoring range.

Generally, in performance monitoring, the range of the performance values of interest to the user is specified. Accordingly, the monitoring range (the maximum/minimum values of the monitoring range) is set in the monitoring code. At this time, for setting the monitoring range properly, the output performance value when performing the monitoring using the monitoring code should be referred.

The monitoring code generated by the monitoring code generator 121 is a code for monitoring range analysis, which is not set the monitoring range. Accordingly, the monitoring range analyzer 130 measures the performance by executing the analytical application 124, which is set the monitoring code, and detects the monitoring range of the monitoring location candidate based on performance data.

To this end, the monitoring range analyzer 130 may include a monitoring code line identifier 131, a monitoring range analysis application executer 132, and a monitoring range candidate generator 133.

The monitoring code line identifier 131 may identify a source line, that is monitoring location candidate, in which a monitoring code is installed, from a source file of the analytical application 124.

The monitoring range analysis application executer 132 may execute the analytical application 124 in which the monitoring code is installed.

The monitoring range candidate generator 133 may detect a monitoring range of the source line identified by the monitoring code line identifier 131.

For example, when the analytical application 124 is executed by the monitoring range analysis application executer 132, the monitoring code may measure performance of a source line in which the monitoring code is installed, and measured performance data may be used as a monitoring range of the corresponding source line.

Here, the performance data may include, for example, frame per second (FPS) information, etc.

If the monitoring location candidate is multiple, the monitoring range candidate generator 133 may detect the monitoring range of each of the monitoring location candidates. At this time, the monitoring range analysis application executer 132 may sequentially activate the monitoring code of each of the monitoring location candidates through the monitoring code activation/non-activation processor 123, and detect the monitoring range of each of the monitoring location candidates.

Also, the monitoring range candidate generator 133 may include the detected monitoring range of a specific source line in a second storage unit 134.

A monitoring range candidate stored in the second storage unit 134 may include a plurality of monitoring ranges, and the number of monitoring ranges may be variously changed.

Although the first and second storage units 114 and 134 are illustrated as separate components in FIG. 1, it will be apparent that the first and second storage units 114 and 134 may be implemented as one component.

The monitoring environment configurator 140 may receive the general application 10 input, to generate a self adaptive application 20.

To this end, the monitoring environment configurator 140 may include a monitoring location configurator 141 and a monitoring range configurator 142.

The monitoring location configurator 141 may determine a monitoring location candidate having the greatest execution load as an optical monitoring location, and install an application monitoring application program interface (API) (monitoring code) in a source line corresponding to the optical monitoring location among the source lines included in the source file of the general application 10. At this time, the execution load may be a CPU utilization. The monitoring location configurator 141 may execute the analytical application 124 set the monitoring range of each of the monitoring location candidates, measure the execution load of the each of the monitoring location candidates, and determine a monitoring location candidate having the greatest execution load as an optical monitoring location.

The monitoring range configurator 142 may provide the application monitoring API with the monitoring range detected by the monitoring range analyzer 130.

Thus, the application monitoring API can perform performance monitoring of the self-adaptive application 20, based on the detected monitoring range.

At this time, the monitoring range configurator 142 may extract a monitoring range corresponding to the corresponding the optical monitoring location in the monitoring range candidate stored in the second storage unit 134, and use the extracted monitoring range.

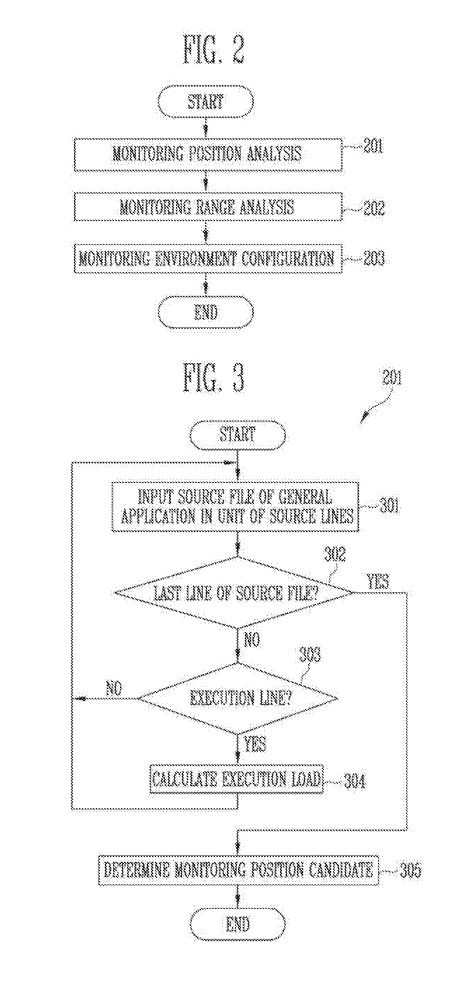

FIG. 2 is a flowchart illustrating a method for configuring a monitoring environment of an application according to an embodiment of the present disclosure.

Referring to FIG. 2, the method according to the embodiment of the present disclosure may include a monitoring location analysis step 201, a monitoring range analysis step 202, and a monitoring environment configuration step 203.

In the monitoring location analysis step 201, a monitoring location candidate may be detected using a general application 10.

In the monitoring range analysis step 202, an analytical application 124 for monitoring range analysis, in which a monitoring code is installed may be generated using the general application 10, and a monitoring range of a source line in which the monitoring code is installed may be measured by executing the analytical application 124.

In the monitoring environment configuration step 203, a self-adaptive application 20 in which an application monitoring API is installed may be generated using the general application 10.

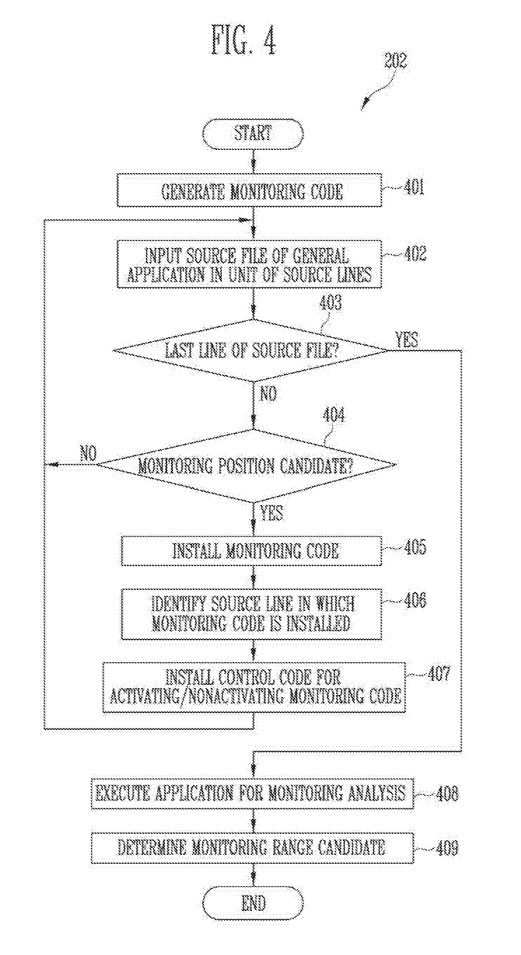

Hereinafter, each of the steps 201, 202, and 203 will be described in detail with reference to FIGS. 3 to 5.

FIG. 3 is a flowchart illustrating the monitoring location analysis step of FIG. 2.

Referring to FIG. 3, in the monitoring location analysis step 201 according to the embodiment of the present disclosure, a step 301 of receiving the source file of the general application 10, input in units of source lines, may be first performed.

After that, a step 302 of confirming whether an input source line is the last line of the corresponding source file may be performed.

When the input source line is not the last line, a step 303 of confirming whether the input source line is an execution line may be performed.

When the input source line is the execution line, a step 304 of calculating an execution load of the corresponding source line may be performed.

When the input source line is not the execution line, the step 301 may be again performed so as to input a next source line.

As the above-described steps are repeated, a plurality of execution lines may be detected, and an execution load of each of the execution lines may also be detected.

Here, the execution load may be determined by reflecting at least one of a number of execution times of a corresponding source line and a CPU utilization of the corresponding source line.

After the above-described steps are repeated, when the input source line corresponds to the last line, a step 305 of determining a monitoring location candidate may be performed.

In the step 305, a source line having the greatest execution load may be determined as the monitoring location candidate.

For example, a source line having the greatest execution load among at least one source line identified as the execution line may be determined as the monitoring location candidate.

The monitoring location candidate may include a source line having an execution load within a certain ranking, in addition to the source line having the greatest execution load.

That is, the monitoring location candidate may include a plurality of source lines according to a configuration of a developer, a user, or the like. For example, the monitoring location candidate may include n (n is a natural number of 2 or more) source lines from the highest rank, based on the execution load.

Information on the monitoring location candidate may be stored in the first storage unit 114.

The monitoring location analysis step 201 may be performed by the monitoring location analyzer 110 described above.

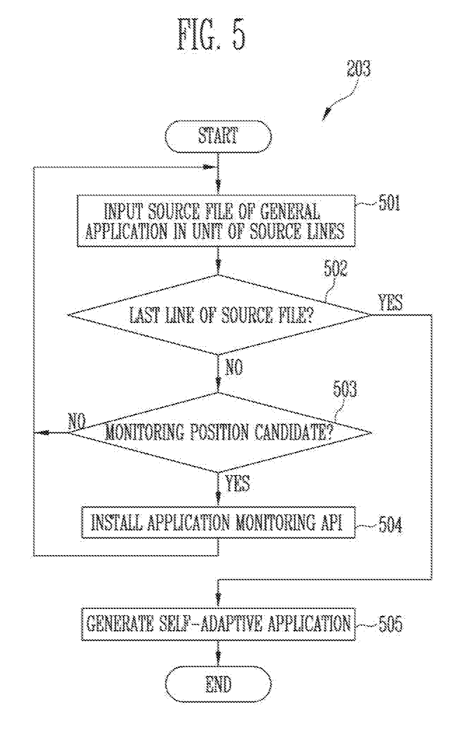

FIG. 4 is a flowchart illustrating the monitoring range analysis step of FIG. 2.

Referring to FIG. 4, in the monitoring range analysis step 202 according to the embodiment of the present disclosure, a step 401 of generating a monitoring code may be first performed.

Then, a step 402 of receiving the source file of the general application 10, input in units of source lines, may be performed.

After that, a step 403 of confirming whether an input source file is the last line of the corresponding source file may be performed.

When the input source line is not the last line, a step 404 of confirming whether the input source line is a monitoring location candidate may be performed.

When the input source line is the monitoring location candidate, a step 405 of installing the monitoring code in the corresponding source line may be performed.

When the input source line is not the monitoring location candidate, the step 402 may be again performed so as to input a next source line.

After the monitoring code is installed in the monitoring location candidate, a step 406 of identifying the source line in which the monitoring code is installed may be performed.

After that, in order to control whether the monitoring code is to be activated, a step 407 of installing a control code capable of activating/non-activating the monitoring code in the source line identified in the step 406 may be performed.

As the above-described steps are repeated, an analytical application 124 for monitoring range analysis, in which at least one monitoring code is installed, may be generated.

After the above-described steps are repeated, when the input source line corresponds to the last line, a step 408 of executing the analytical application 124 may be performed.

After that, a step 409 of detecting a monitoring range of the source line in which the monitoring code is installed, using performance data generated in the step 408 of executing the analytical application 124, may be performed.

For example, when the analytical application 124 is executed in the step 408, each monitoring code may measure performance of a corresponding source line, and measured performance data may be used as a monitoring range of the corresponding source line.

Therefore, a monitoring range for each monitoring location candidate may be detected, and information on the monitoring range detected in the step 409 may be stored in the second storage unit 134.

The monitoring range analysis step 202 may be performed by the monitoring range analysis code configurator 120 and the monitoring range analyzer 130, which are described above.

FIG. 5 is a flowchart illustrating the monitoring environment configuration step of FIG. 2.

Referring to FIG. 5, in the monitoring environment configuration step 203 according to the embodiment of the present disclosure, a step 501 of receiving the source file of the general application 10, input in units of source lines, may be first performed.

After that, a step 502 of confirming whether an input source line is the last line of the corresponding source file may be performed.

When the input source line is not the last line, a step 503 of confirming whether the input source line is a monitoring location candidate may be performed.

When the input source line is the monitoring location candidate, a step 504 of installing an application monitoring API in the corresponding source line may be performed.

Here, the application monitoring API may have the monitoring range detected by the above-described step 409.

Thus, the application monitoring API can perform performance monitoring on the self-adaptive application 20, based on a configured monitoring range.

When the input source line is not the monitoring location candidate, the step 501 may be again performed so as to input a next source line.

After the above-described steps are repeated, when the input source line corresponds to the last line, a step 505 of generating the self-adaptive application 20 may be performed.

As a result, the self-adaptive application 20 in which at least one application monitoring API is installed can be generated through the above-described steps.

The monitoring environment configuration step 203 may be performed by the monitoring environment configurator 140.

According to the above-described method, it is possible to acquire an optimal monitoring location and an optimal monitoring, range for performance monitoring of an application. Accordingly, an optimal monitoring environment can be easily configured even though additional efforts are not made.

As described above, according to the present disclosure, an optimal monitoring location and an optimal monitoring range for configuring an optimal monitoring environment can be automatically acquired from an application without understanding of self-adaptive systems and runtimes of self-adaptive applications.

Also, according to the present disclosure, it is possible to solve difficulty caused by the existing monitoring environments depending on developers' experiences. Further, it is possible to eliminate limitations in the use of self-adaptive applications, which are caused by the existing monitoring environments.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for analyzing application for measuring performance of applications, the method comprising:
detecting at least one monitoring location candidate in an input application;
generating, an analytical application using the application and the at least one monitoring location candidate;
detecting monitoring range of each of the at least one monitoring location candidate through the analytical application; and
determining a monitoring location candidate having the greatest execution load among the at least one monitoring location candidate as an optimal monitoring location for monitoring the performance of the application.

2. The method of claim 1, wherein the execution load includes CPU utilization.

3. The method of claim 1, wherein detecting the at least one monitoring location candidate comprises:
arbitrarily executing the application;
counting the number of execution times of the at least one execution line of the application while the input application is executing; and
determining at least one execution line as the at least one monitoring location candidate based on the counted number of execution times.

4. The method of claim 1, wherein generating the analytical application comprises:
inserting a monitoring code into the at least one monitoring location candidate of the application.

5. The method of claim 1, wherein the monitoring range is a range of performance values of interest of the application.

6. The method of claim 4, wherein detecting the monitoring range of each of the at least one monitoring location candidate comprises:
measuring performance values of each of the at least one monitoring location candidate by executing the analytical application;
determining a range of performance values of interest of each of the at least one monitoring location candidate from the measured performance values; and
setting the determined range of performance values of interest as the monitoring range of each of the at least one monitoring location candidate.

7. The method of claim 6, wherein setting the determined range of performance values as the monitoring range comprises:
inserting the determined range of performance values into the monitoring code as the monitoring range.

8. The method of claim 6, wherein determining the monitoring location candidate having the greatest execution load among the at least one monitoring location candidate as the optimal monitoring location comprises:
executing the analytical application set the monitoring range;
calculating the execution load of each of the at least one monitoring location candidate; and
determining, the monitoring location candidate the greatest execution load among the at least one monitoring location candidate as the optimal monitoring location.

9. The method of claim 1, further comprising:
generating a self-adaptive application by inserting a monitoring code into the optical monitoring location setting the monitoring range to the optical monitoring location.

10. The method of claim 1, the performance is QoS (Quality Of Service) of the applications.

11. An apparatus for analyzing application measuring performance of applications, the apparatus comprising:
a monitoring location analyzer detecting at least one monitoring location candidate in an input application;
a monitoring range code configuration generating an analytical application using the application and the at least one monitoring location candidate;
a monitoring range analyzer detecting monitoring range of each of the at least one monitoring location candidate through the analytical application; and
a monitoring environment configurator determining a monitoring location candidate having the greatest execution load among the at least one monitoring location candidate as an optimal monitoring location for monitoring the performance of the application.

12. The apparatus of claim 11, herein the execution includes CPU utilization.

13. The apparatus of claim 11, wherein the monitoring location analyzer arbirtarily executes the application; counts the number of execution times of the at least one execution line of the application while the input application executing; and determines at least one execution line as the at least one monitoring location candidate based on the counted number of execution times.

14. The apparatus of claim 11, wherein the monitoring range code configurator inserts a monitoring code into the at least one monitoring location candidate of the application.

15. The apparatus of claim 11, wherein the monitoring range is a range of performance values of interest of the application.

16. The apparatus of claim 14, wherein the monitoring range analyzer measures performance values of each of the at least one monitoring location candidate by executing the analytical application; determines a range of performance values of interest of each of the at last one monitoring location candidate from the measured performance values; and sets the determined range of performance values of interest as the monitoring range of each of the at least one monitoring location candidate.

17. The apparatus of claim 16, wherein the monitoring range analyzer inserts the determined range of performance values into the monitoring code as the monitoring range.

18. The apparatus of claim 16, wherein the monitoring environment configurator executes the analytical application set the monitoring range; calculates the execution load of each of the at least one monitoring location candidate; and determines the monitoring location candidate having the greatest execution load among the at least one monitoring location candidate as the optimal monitoring location.

19. The apparatus of claim 11, the monitoring environment configurator generates a self-adaptive application by inserting a monitoring code into the optical monitoring location and setting the monitoring range to the optical monitoring location.

20. The apparatus of claim 11, the performance is QoS (Quality Of Service) of the applications.
